(19) United States
(12) Patent Application Publication
(10) Pub. No.: US 2015/0200984 A1
(43) Pub. Date: Jul. 16, 2015

(54) SYSTEM FOR SHARING MULTIMEDIA DATA IN REALTIME WIRELESS MANNER FOR THE PURPOSE OF EXTENDING VISION

(71) Applicant: MtoV Inc., Daejeon (KR)

(72) Inventors: Sangsu JUNG, Seoul (KR); Eunjung Lee, Seoul (KR)

(21) Appl. No.: 14/520,748

(22) Filed: Oct. 22, 2014

(30) Foreign Application Priority Data
Jan. 13, 2014 (KR) 10-2014-0003725

(51) Int. Cl. H04L 29/06; G06Q 50/26

(52) U.S. Cl. CPC H04L 65/403; G06Q 50/265

(57) ABSTRACT

The present disclosure relates to a system for sharing network multimedia data in realtime wireless manner for the purpose of extending vision, including, in accordance with one exemplary embodiment of the present invention, a first display portion which displays a first image of outside condition taken by a first camera unit included in a first device; and a second display portion which displays a second image of the first device taken by a second camera unit included in the first device and a plurality of a second device, and having the first device and the second device connected on a same mobile ad hoc network, over which the second image is transmitted from a plurality of the second devices to the first device.

### CROSS-REFERENCE TO RELATED APPLICATION

This application claims the priority of the Korean Patent Application No. 10-2014-0003725 filed on Jan. 13, 2014 in the Korean Intellectual Property Office, and all the benefits accruing therefrom under 35 U.S.C. §119, the contents of which in their entirety are herein incorporated by reference.

### TECHNICAL FIELD

The present invention relates to a system for sharing multimedia data in realtime wireless manner for the purpose of extending vision, and more particularly, to a system for sharing multimedia data in realtime wireless manner for the purpose of extending vision, wherein a prescribed amount of multimedia data can be shared over a mobile ad hoc network.

### Background Art

A mobile ad hoc network refers to a network which is self-organized by wireless nodes without any infrastructure such as a base station or cable. Mobile ad hoc nodes transceive data by using wireless interface, and the network topology changes dynamically. Its application field includes vehicular networks, military networks, and temporary public networks.

The conventional art for sharing multimedia data is intended for a system for transmitting multimedia data, which is immovable, such as CCTV, and the transmitted image is displayed on an immovable output device by wire or wireless.

For the data management technology linked with mobile network, there is a content delivery network or a disruption-tolerant network, wherein the data is cached to a certain level, and then directly transmitted wirelessly upon request.

### DISCLOSURE OF INVENTION

### Technical Problem

The conventional mobile ad hoc network cannot provide a user-level realtime service because it is not designed to be suitable for delay-sensitive traffic of image. Particularly, it sets up a plurality of unspecified nodes in a same network group, incurring the data's competing for transmission, thereby deteriorating the performance due to frequent loss of data packet and prolonged waiting time.

The conventional image collecting device cannot take a picture of the shape or condition of itself, exposed to danger, directly by a camera unit, due to limited directions to take a picture with (the front and the rear). And there are spots, including a blind spot, which cannot be taken due to a limited distance (range) to take a picture from.

The conventional device for sharing multimedia data takes a picture in a fixed state, and then transmits the data over wired network, which has a stable channel condition and wide bandwidth, to be displayed on an outputting device in a fixed state. Accordingly, when the mobility is taken into account, it is impossible to provide a user-level service due to unstable channel condition and relatively low bandwidth. Moreover, a method of collecting and outputting images by a mobile device is absent.

The present invention is to resolve the above mentioned technical issue by providing a system for sharing network multimedia data in realtime wireless manner for the purpose of extending vision which, by combining a plurality of images received from the outside, enables monitoring in three-dimensions all the images not only of the device's own shape and condition but also taken from a long distance, in obstacle zone, and in a blind spot, which are impossible to be captured by the device's own camera unit.

The present invention, in order to resolve another technical issue, is to provide a system for sharing network multimedia data in realtime wireless manner for the purpose of extending vision, which shares collected multimedia data in real time by connecting a mobile device collecting multimedia data to a mobile ad hoc network.

To resolve another technical issue, the present invention is to provide a system for sharing network multimedia data in realtime wireless manner for the purpose of extending vision, which enables sharing of multimedia data by including a limited number of mobile devices in a specific direction, as a node, to a mobile ad hoc network, in order to form a mobile ad hoc network group composed of mobile devices collecting multimedia data.

To resolve further technical issue, the present invention is to provide a system for sharing network multimedia data in realtime wireless manner for the purpose of extending vision, which collects, encrypts, and transmits the related multimedia data in order to prevent from data loss and to respond to an emergency, when a significant impact such as a car accident is applied onto a wireless device for sharing multi-image.

The technical issues the present invention is to resolve are not limited to the above mentioned, but other issues not mentioned herein will be clearly understandable for those having ordinary skill in the art upon description which follows.

### Technical Solution

In order to resolve the above mentioned technical issues, the system for sharing network multimedia data in realtime wireless manner for the purpose of extending vision in accordance with one exemplary embodiment of the present invention includes a first display portion which displays a first image of the outside condition taken by a first camera unit included in a first device, and a second display portion which displays a second image of the first device taken by a second camera unit included in the first device and a plurality of a second devices. The first device and the second device are connected on a same mobile ad hoc network, over which the second image is transmitted from a plurality of the second devices to the first device.

The second image includes a plurality of the outside images of the first device taken from different angles, and the first device displays a monitoring image of the entire exterior of the first device by combining a plurality of the outside images.

The second display portion includes a plurality of sub-display portions which display a plurality of the outside images.

A sensor portion, which detects the amount of impact applied onto the first device, and a control portion, which transmits the first image taken of the first device at the time of accident to a plurality of the second devices over the mobile ad hoc network when the sensor portion detects an impact, may be further included.

The first device or the second device may transmit an accident report data including the first image or the second image to an external server which is collecting accident images.

### Advantageous Effects

The present invention mentioned above has various effects as in the following.

First, the system for sharing network multimedia data in realtime wireless manner for the purpose of extending vision in accordance with the exemplary embodiments of the present invention enables monitoring of a host device in three dimensions by providing the images acquired from the host device, combined with the images of the host device taken from the outside from different angles. In particular, such images taken from the outside are useful for grasping the condition of a blind spot and extending a range of vision because it is restrictive for the host device to take a picture of itself.

Second, the system for sharing network multimedia data in realtime wireless manner for the purpose of extending vision in accordance with the exemplary embodiments of the present invention enables preparing for the dangers by checking for the image taken from the outside of a risk factor at long range, which is not seen from the host device. That is, since a person in the host car can detect risk factors beforehand by monitoring the images taken of the outside of the other car, adjacent to the host car, such as a front image of the front car or a rear image of the rear car which are not visible to the person in the host car.

Third, the system for sharing network multimedia data in realtime wireless manner for the purpose of extending vision in accordance with the exemplary embodiments of the present invention has an advantage of providing a user-level service for sharing network multimedia data in real time by limiting the number of the device for transmitting multimedia data, as a node being included in a mobile ad hoc network composed of a single subnet.

Forth, the system for sharing network multimedia data in realtime wireless manner for the purpose of extending vision in accordance with the exemplary embodiments of the present invention enables dual storage management of important data because it transmits the frames taken by itself to an adjacent wireless device for transmitting multi-image in real time, and the wireless device for transmitting multi-image directly saves the transmitted frames.

Fifth, the system for sharing network multimedia data in realtime wireless manner for the purpose of extending vision in accordance with the exemplary embodiments of the present invention solves the problem regarding the protection of information by encrypting and saving the data to send out to a base station, and by allowing only those concerned and identified to access the sensitive data when receiving multimedia data taken of a special circumstance, such as a car accident.

### BRIEF DESCRIPTION OF DRAWINGS

FIG. 1 is a block diagram illustrating an outline of the system for sharing network multimedia data in realtime wireless manner for the purpose of extending vision in accordance with one exemplary embodiment of the present invention.

FIG. 2 and FIG. 3 are diagrams illustrating the relationship among a plurality of devices to which the system for sharing network multimedia data in realtime wireless manner for the purpose of extending vision of FIG. 1 is applied.

FIG. 4 and FIG. 5 are diagrams illustrating a process of sharing multimedia data when a plurality of devices of FIG. 3 is colliding.

FIG. 6 and FIG. 7 are diagrams illustrating an outline of the kind and the angles of the image provided by the system for sharing network multimedia data in realtime wireless manner for the purpose of extending vision in accordance with one exemplary embodiment of the present invention.

FIG. 8 is a block diagram illustrating a device which comprises the system for sharing network multimedia data in realtime wireless manner for the purpose of extending vision in accordance with another exemplary embodiment of the present invention.

FIG. 9 is a flow chart describing a method of forming a mobile ad hoc network group by devices of the system for sharing network multimedia data in realtime wireless manner for the purpose of extending vision in accordance with the exemplary embodiments of the present invention.

### BEST MODE FOR CARRYING OUT THE INVENTION

A desirable exemplary embodiment of the present invention will be described in detail hereinafter in reference with the accompanied drawings. The advantage and characteristic, and a method to achieve them will be obvious upon detailed description of the exemplary embodiments as well as accompanied drawings which follow. However, the present invention is not limited to the exemplary embodiments set forth herein, but can be embodied in many different forms. The exemplary embodiments are provided only to render the present disclosure complete and the scope of the present invention comprehensible to those having ordinary skill in the art. The present invention is only to be defined by the claims. A reference mark used refers to a same element throughout the description.

Without separate definitions, all terms (including technical and scientific terms) used in the present description may be used for the meanings commonly understandable for those having ordinary skill in the art. In addition, the terms generally used and having definitions in dictionary, unless otherwise defined obviously in particular, should not be ideally or exaggeratedly interpreted.

The terms used in the present description are to explain the exemplary embodiments, not to limit the present invention thereto. In the present description, a singular form of word also includes a plural form thereof unless otherwise noted. The term “comprises” and/or “comprising” is not excluding the meaning that one or more elements other than the said element may exist or be added.

The system for sharing network multimedia data in realtime wireless manner for the purpose of extending vision in accordance with the exemplary embodiments of the present invention will be described in reference with the drawings as in the following.

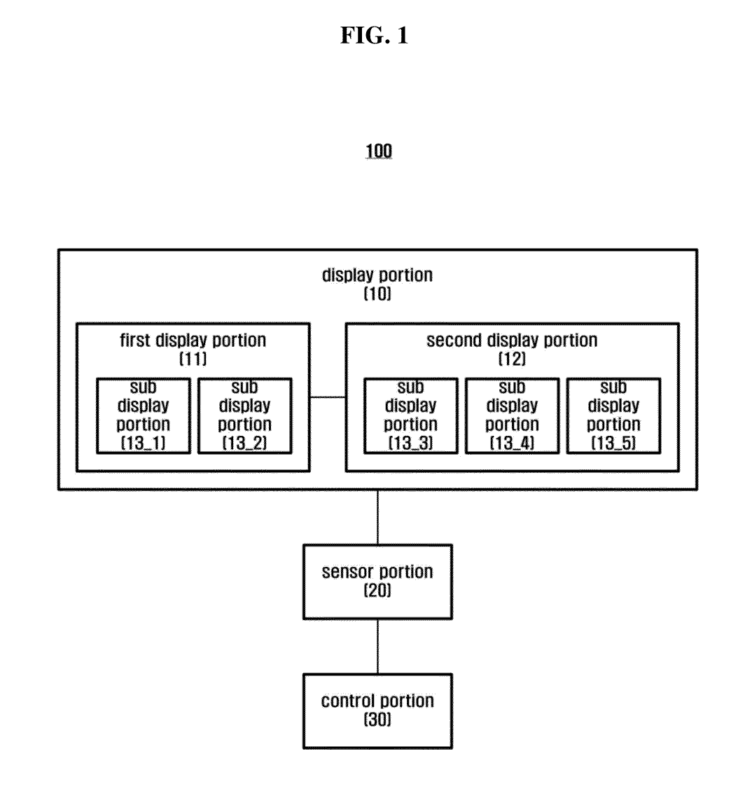

The system for sharing network multimedia data in realtime wireless manner for the purpose of extending vision (100) in accordance with one exemplary embodiment of the present invention, shown by FIG. 1, includes a first display portion (11) which displays a first image of the outside condition of the host device taken by a first camera unit included in a first device, and a second display portion (12) which displays a second image of the first device taken by a second camera unit included in the first device and a plurality of a second device. The first device and the second device are connected on a same mobile ad hoc network, and the second image is transmitted over the mobile ad hoc network from the second device to the first device.

A display portion (10) includes the first display portion (11) and the second display portion (12). The first display portion (11) and the second display portion (12) may have separate display devices, respectively, while not limited thereto, and each of the display portions may also display a divided screen, respectively, on one display device. And the display portion (10) may further include an element more than a third display portion.

In a several other exemplary embodiments, the display portion (10) may include a plurality of display portions on which maps each image source one by one, and display a plurality of images on divided screens of one display portion (10). For example, the first display portion (11) can display each of the front and rear images of the first device on the sub-display portions (13_1, 13_2), respectively, and on an additional sub-display portion, displays the side image of a blind spot at the same time. In order for that, the first device may include a plurality of camera units which take pictures from various angles such as from the right and left, or from the front and rear.

In other words, the first display portion (11) displays the first image of the outside taken by the first device, and the first image may include a first information about a surrounding area, such as a shape of surrounding road or a land shape, and about distribution or location of the surrounding devices existing on the same network.

In this exemplary embodiment, the first device and the second device refer to various kinds, including a mobile device mutually transmitting data, connected on the network, or the various means equipped with such mobile devices, while not limited thereto. In addition, the first device and the second device may include a driving gear such as a vehicle, and a remote control driving gear, but the kind of device is not limited thereto.

The second display portion (12) displays the second image received from a plurality of the second devices (the surrounding devices) existing in a prescribed range of the first device as a host device. That is, a plurality of devices connected on a prescribed network can share each other's condition and views by sharing the multimedia data, such as an image, with each other. A plurality of devices may include a camera module which generates multimedia data by taking pictures of the interior or exterior. In other words, by sharing each other's image over a prescribed network in real time, even on emergency such as a car accident on the first device, all the images available until the network stops working can be shared since the first device having already transmitted the image to a plurality of the second devices existing in the surrounding area. For example, in case of physical accident happened with a certain amount of impact, the first device can send out the message about the impact to a plurality of the second devices in the surrounding area, and a plurality of the second devices can extract the images in the section of the accident from the received images on the basis of the message about the impact, and transmit the images to the outside.

The second image may include a plurality of images received from the second device, for example, the images taken from the front, rear, left, and right side of the first device. Or, the second image may include the image of the first device taken with a certain angle from a plurality of the second devices distributed around the first device.

In several other exemplary embodiments, the second image may include at least one image selected from the group consisting of the images taken from the front, rear, left and right side of the second device. The second image may be received from a plurality of different second devices. For example, in case the second device transmitting the second image is located at the back of the first device, the second device takes pictures of the images from the front, rear, and the left and right sides, and transmits the images to the first device in real time. Although the first device cannot recognize the condition at the rear of the second device existing in the back of the first device due to a restrictive vision, sharing of the rear image of the second device with the first device enables the first device to recognize the condition at the rear of the second device as well as that of its own.

Thus, when a plurality of the second device exist around the first device, and transmits a plurality of the second images to the first device, the various images from a range, to which the first device cannot reach, can be obtained.

In addition, the host device and its surrounding devices are connected on a same mobile ad hoc network, and the first image taken by the first device and a plurality of the second images taken by the second device can be shared with each other over the mobile ad hoc network.

In the present exemplary embodiment, the number of the devices which are sharing with each other over a mobile ad hoc network is restrictive. For example, a network can be composed of the first device, as a host device, one second device located in the front of the first device, and two of the third devices (having same composition with that of the second device) located in the rear of the first device, however, a composition not limited thereto. The device located on the side of the first device or in a specific angle from the first device can be selectively connected to a mobile ad hoc network.

In addition, when there is no valid device which can be connected to a mobile ad hoc network and share images, among the devices (remote devices) existing outside of the mobile ad hoc network, a device located in the closest or at a desired location can be exceptionally adopted, and the images of the remote device can be transmitted via base station or mediation server. And also the images can be transmitted from the first device, as a host device, to the remote device via base station or mediation server. In several other exemplary embodiments, the second image includes a plurality of the outside images taken of the first device from different angles, and the first device may display a monitoring image of the entire exterior of the first device by combining a plurality of the outside images. And the second display portion may include a plurality of sub-display portions (13_3, 13_4, 13_5) which display a plurality of outside images. In other words, for example, when there are the first device as a host device and three of the second devices around the first device, three images transmitted from the second devices can be displayed on three corresponding sub-display portions (13_3, 13_4, 13_5), respectively. The above mentioned number of the sub-display portion (13) is only for example, each display portion (11, 12) can include a plurality of sub-display portions.

A sensor portion (20) detects the amount of impact applied onto the body of its own, and transmits the message to a control portion (30). The sensor portion (20) may include various compositions which detect the amount of impact applied from the inside or the outside

The control portion (30) controls the display portion (10) and the sensor portion (20), and more particularly, processes the multimedia data received over mobile ad hoc network and delivers the processed data to the display portion (10), and displays the first information on the basis of the previously stored data.

In addition, the control portion (30) delivers the first image taken at the time the accident took place, from the first device to a plurality of the second devices (the surrounding devices) over the mobile ad hoc network when the sensor portion (20) detects the impact; at this, the second image already received from a plurality of the second devices can be transmitted again to the second devices. In other words, since each second device recognizes only the second image transmitted by itself, it can be set up that all the second images generated from the second devices can be shared with each other in an accident. In the present description, the term “accident” refers to all kinds of event wherein the impact is detected on the host device or the surrounding devices. Or, as previously described, when the impact is detected, only the message or signal about the impact can be transmitted while the images are not repeatedly transmitted as the images have already been shared in real time. The device which received the message or signal may also extract and deliver the images relative to the accident to the outside.

The control portion (30) can transmit the second image received from the outside to the display portion (10), and also transmit the first image acquired from the host device on its own to the surrounding device in the outside.

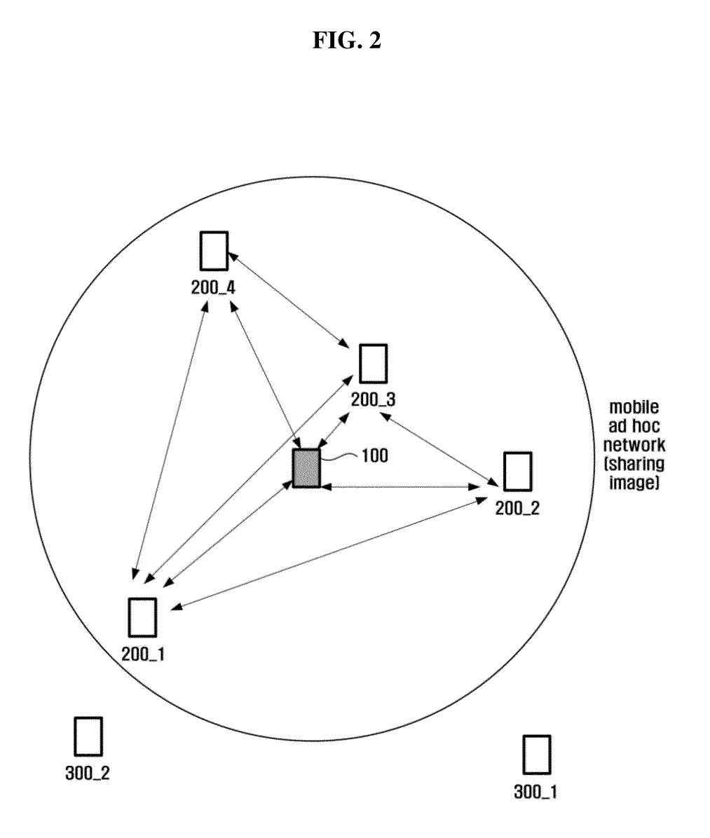

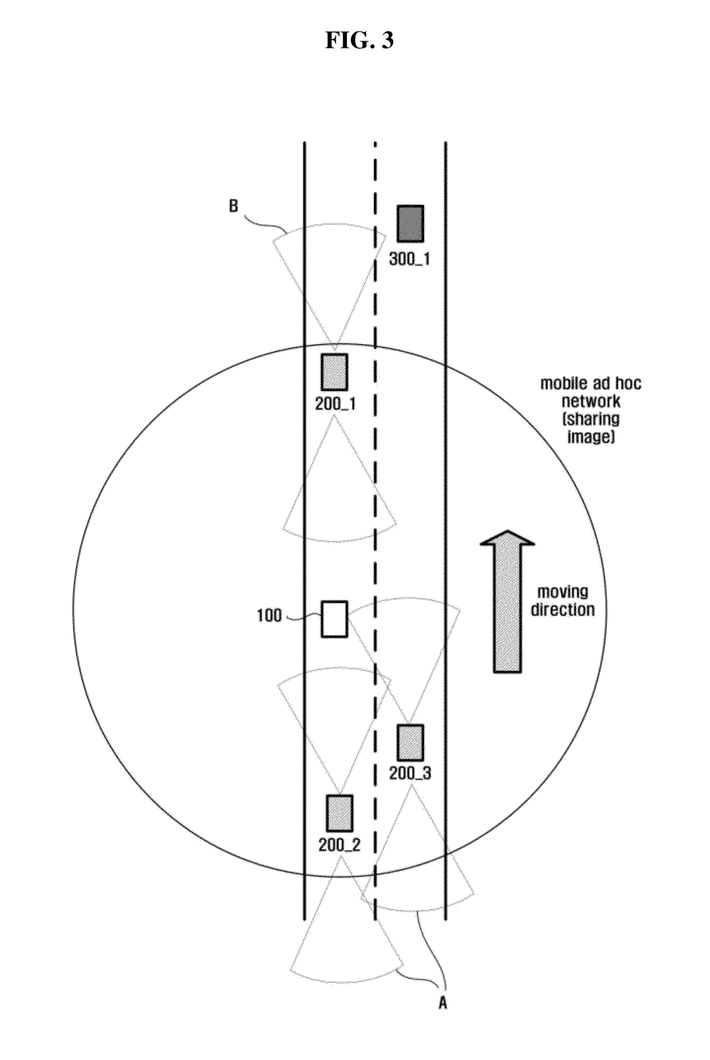

FIG. 2 and FIG. 3 show exemplary embodiments of the system for sharing network multimedia data in realtime wireless manner for the purpose of extending vision (100) in various devices.

In reference with FIG. 2, a mobile ad hoc network is established in a prescribed range of the host device (100) as its center, and the surrounding devices (200_1, 200_2, 200_3; marked as 200 hereinafter) existing on the network share a certain amount of images with each other as well as with the host device (100). Such an image sharing can be made as a result of a specific event, or by periodically outputting the images received from another device.

As shown by the drawing, since not only the front and rear images of the host device (100) but also those of the surrounding device (200_1) located in the front of the host device (100), and of the surrounding devices (200_2, 200_3) located in the rear of the host device (100) are shared with each other, a clear view can be secured by checking the rear image (A) of the surrounding devices (200_2, 200_3) located in the rear, or the front image (B) of the surrounding device (200_1) located in the front, which are difficult to be seen from the host device.

As previously described, the host device (100) and the surrounding device (200) can be of various forms which transceive data over network.

Although non-surrounding devices (300_1, 300_2) which are not connected with the host device (100) cannot share images over a mobile ad hoc network, they can share images with each other by means of communications other than mobile ad hoc network, such as mobile or broadband.

FIG. 3 shows an exemplary embodiment wherein the host device (100) and the surrounding device (200) are the car itself in motion, or the module equipped inside of the car. That is, the host device (100) as the car of one's own and the cars in a prescribed range can share each other's images by communicating over the mobile ad hoc network.

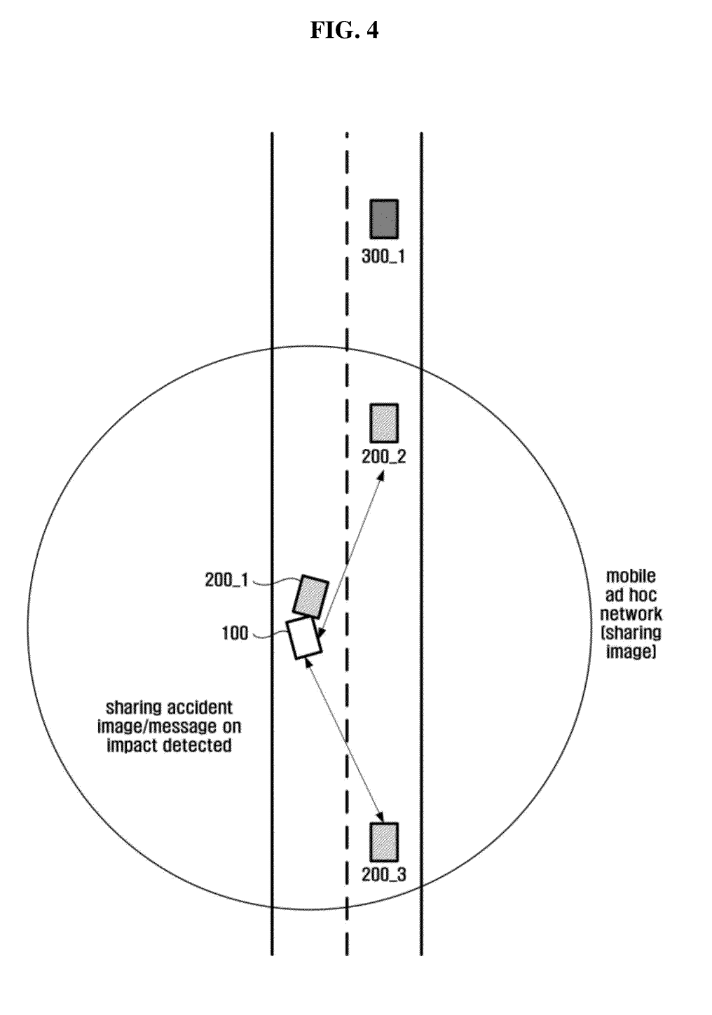

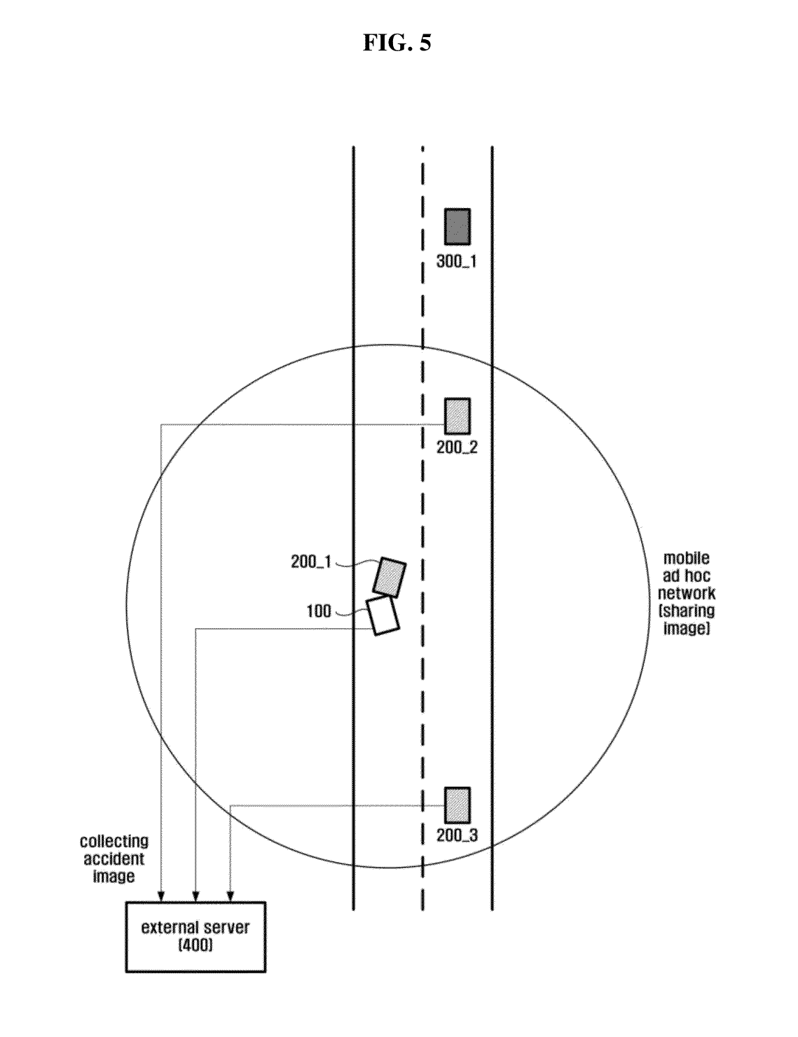

FIG. 4 and FIG. 5 shows a process of sharing images when the host device (100) detects an impact.

In reference with FIG. 4, in case the host car (100) and the other car (200_1) collide, and the impact is detected on the host car (100), the host car (100) can transmit the black box images taken before and after the collision to the surrounding cars (200_2, 200_3) existing on the mobile ad hoc network in order to share the images of accident. Although not shown by the drawing, the other car (200_1) in accident also transmits the images to the surrounding cars (200_2, 200_3) connected on the mobile ad hoc network.

In reference with FIG. 5, the control portion of the surrounding device, that is, the surrounding cars (200_2, 200_3), or the host device, that is, the host car (100), transmits the accident report data including the first image or the second image to an external server (400), and the external server (400) collects such images of accident. For example, the external server (400) can be arranged in the place related to a car, such as an insurance company, police station or hospital. The external server (400), by collecting images from various angles for a single accident, contributes to the improvement of reliability and accuracy of judgment.

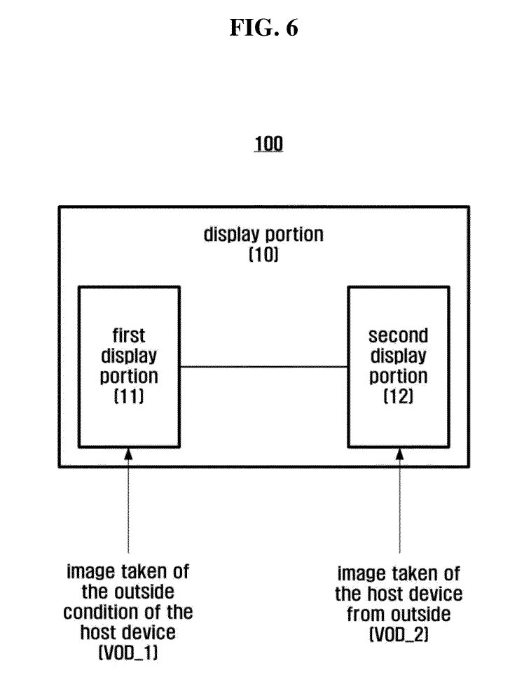

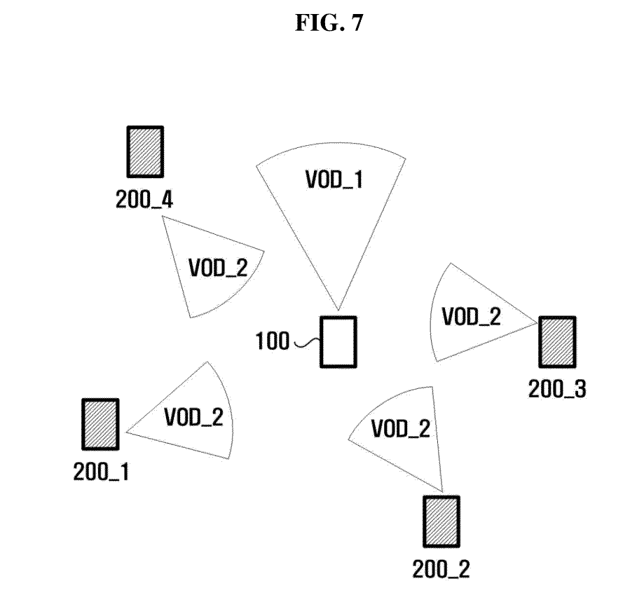

FIG. 6 and FIG. 7 show an outline of the kind and the angle of the images of the system for sharing network multimedia data in realtime wireless manner for the purpose of extending vision in accordance with one exemplary embodiment of the present invention. In reference with FIG. 6 and FIG. 7, the first image (VOD_1) taken of the outside condition of the host device is outputted on the first display portion (11). On the second display portion (12), the second image (VOD_2) of the host device taken from the outside is outputted. In other words, the first display portion (11) and the second display portion (12) display the first image (VOD_1) of the outside condition of the first device (100) taken by itself and the second image (VOD_2) of the first device (100) or the adjacent area around the first device (100) taken by a plurality of the second devices (200_1, 200_2, 200_3, 200_4) located around the first device (100), respectively.

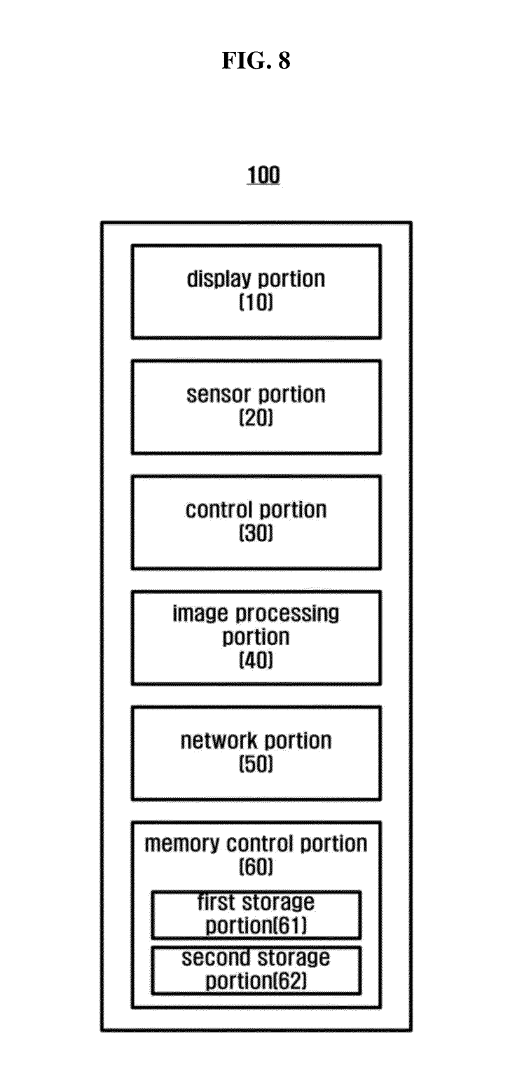

FIG. 8 shows a composition of the device comprising the system for sharing network multimedia data in realtime wireless manner for the purpose of extending vision in accordance with another exemplary embodiment of the present invention, which may further include an image processing portion (40), a network portion (50), and a memory control portion (60), as well as the display portion (10), the sensor portion (20), and the control portion (30), which are previously explained.

The image processing portion (40) records an image acquired from an image taking portion (not shown), and extracts a specific frame of the image when the impact is detected, or periodically.

The network portion (50) selects a single or a plurality of surrounding devices to be included on the mobile ad hoc network in consideration of the link expiration time and the distance between the devices, and transmits the extracted image frame to a device selected from the network group, to an external server, or to a base station.

The memory control portion (60) records and maintains each of the images recorded and transmitted. The memory control portion (60) assures fast memory access by properly distributing and saving data to, and extracting the data from, a dual memory composed of the first storage portion (61) and the second storage portion (62), depending upon the origin of data.

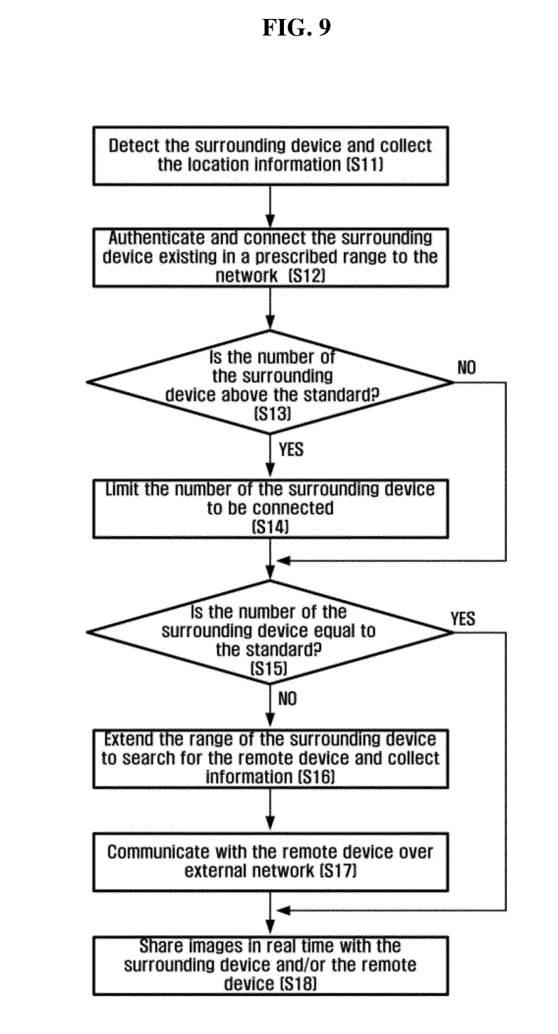

FIG. 9 is a flow chart describing a method of forming mobile ad hoc network group by the devices of the system for sharing network multimedia data in realtime wireless manner for the purpose of extending vision.

The device comprising the system for sharing network multimedia data in realtime wireless manner for the purpose of extending vision will be hereinafter called a network multimedia device.

The host device (the body), comprising the system for sharing network multimedia data in realtime wireless manner for the purpose of extending vision in accordance with the exemplary embodiments of the present invention, detects the devices around itself either in motion or static, and collects the location information of the relevant devices (S11). Then, it checks whether the detected device is within a prescribed range, and authenticates and connects the device over the network (S12). The range can vary depending upon the kind of network. When the mobile ad hoc network is used, the range can be determined in consideration of the range of data transmission or traffic. In addition, the number of node connected on the network can be restrictive. That is, the number of the surrounding device arranged in the front of the host device and that of the surrounding device arranged in the rear of the host device can be restrictive. For example, one surrounding device can be arranged in the front of the host device, and two or three of the surrounding devices can be arranged in the rear. That is, the number of total devices including the host device and the surrounding devices which share images in real time on a single network can be limited to four or five.

Moreover, in case the number of the surrounding devices detected are above the prescribed number as a standard, the number of the connected surrounding devices can be limited to a standard (S14) in overall consideration of the order of shortest distance, the condition of network connection, and the preferred location.

The host device determines whether the number of the surrounding device is equal to a standard (S15), and if so, can share images in real time with the surrounding devices.

On the other hand, in case the number of the surrounding device is below the standard, the range of the surrounding device can be extended for searching of a remote device and the data thereof can be collected (S16). And, the host device can communicate with the remote deice over an external network (S17), for example, a base station for mobile communication, mediation server, repeater, and sharing device, wherein the host device can share images in real time with the surrounding device and/or the remote device (S18).

It is clearly understandable for those having ordinary skill in the art the present invention can be embodied in various forms, other than the exemplary embodiments set forth herein, without changes in its technical idea or essential characteristic. The exemplary embodiments described herein are only for the purpose of exemplifying the present invention in all aspects, not of limiting the scope of the present invention.

### DESCRIPTION FOR MARKS

10: display portion
20: sensor portion
30: control portion
40: image processing portion
50: network portion
60: memory control portion

1. A system for sharing network multimedia data in realtime wireless manner for the purpose of extending vision, comprising
a first display portion which displays a first image of outside condition taken by a first camera unit included in a first device; and
a second display portion which displays a second image of outside condition taken by a second camera unit included in the first device and a plurality of a second device,
wherein the first device and the second device are connected on a same mobile ad hoc network, and
the second image is transmitted from a plurality of the second devices to the first device over the mobile ad hoc network.

2. According to claim 1,
a system for sharing network multimedia data in realtime wireless manner for the purpose of extending vision, wherein
the second image includes a plurality of images taken of outside of the first device from different angles, and
the first device displays a monitoring image of entire exterior of the first device by combining a plurality of the outside images.

3. According to claim 1,
a system for sharing network multimedia data in realtime wireless manner for the purpose of extending vision, wherein
the second display portion further display a third image taken from outside of the mobile ad hoc network, and
the third image is transmitted to the first device over an external network.

4. According to claim 1,
a system for sharing network multimedia data in realtime wireless manner for the purpose of extending vision, further comprising
a sensor portion which detects an amount of impact applied onto the first device; and a control potion which transmits the first image of the first device at the time an accident took place to a plurality of the second devices over the mobile ad hoc network when the sensor portion detects an impact.

5. According to claim 4,
a system for sharing network multimedia data in realtime wireless manner for the purpose of extending vision, wherein
the first device or the second device transmits an accident report data including the first image or the second image to an external server which collects an image of accident.
